(19) United States
(12) Patent Application Publication
(10) Pub. No.: US 2005/0178778 A1
(43) Pub. Date: Aug. 18, 2005

(54) System and method for monitored delivery of products

(76) Inventors: Michael D. Berg, Winfield, IL (US); Scott R. Lang, Geneva, IL (US); Liana Maria Kiff, Excelsior, MN (US)

Correspondence Address: Patent Services Group;Honeywell International, Inc., 101 Columbia Road, P.O. Box 2245, Morristown, NJ, 07962, US

(21) Appl. No.: 10/741,998

(22) Filed: Dec. 19, 2003

(51) Int. Cl. G07F 11/00

(52) U.S. Cl. 221/7

(57) ABSTRACT

A device for dispensing products senses when the respective products are accessed. A signal indicative of day and time of access can be transmitted to a remote monitoring station. Received signals can be compared to a pre-established schedule.

### FIELD OF THE INVENTION

The invention pertains to monitored product delivery systems. More particularly, the invention pertains to monitored medication delivery systems.

### BACKGROUND

In circumstances where it is desirable or important to be able to dispense products, for example, daily in a timely manner, manual reminders such as notes and the like can be used to remind the individual or individuals who are supposed to access the products as to the schedule. At times, even in the best of the circumstances, it is difficult to remember such schedules. One particular example where many individuals interface with such schedules is in connection with taking medication. Particularly, as individuals age, they may have a medication schedule which runs from day to day on a repetitive basis, but which may require taking one or more prescription drugs in accordance with that schedule.

At times, the individual or individuals may be alone. Care givers may not be present during the times and/or days when the medications are to be taken. Nevertheless, it would be desirable to be able to track the individual's adherence to the respective schedule.

There thus continues to be a need for systems and methods of tracking adherence to product delivery schedules. Preferably, such systems and methods could carry out the desired tracking function automatically and transparently where the schedule is consistently being adhered to. In instances where there is a deviation from a preset schedule, follow up could preferably be provided relatively promptly.

### BRIEF DESCRIPTION OF THE DRAWINGS

FIG. 1 is a perspective view of a product dispensing unit in accordance with the invention; and

FIG. 2 is a block diagram of an electronic system which can incorporate a plurality of the dispensing units of FIG. 1.

### DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

A disclosed embodiment of a product delivery station incorporates a plurality of compartments for temporary storage of the respective product or products. Compartments can be associated with days of the week and/or times of the day. When the schedule calls for a product to be accessed, the accessing individual opens the appropriate compartment to obtain the product.

In a disclosed embodiment, when a compartment is opened, a signal or message can be sent, via either a wired or wireless medium, to a monitoring station indicating which compartment has been opened and the time of day. A schedule database at the monitoring station can be used to either automatically or manually compare the data received and the signal or the message to a prerecorded schedule associated with that individual. A determination can be made if the individual is operating in compliance with the schedule.

If non-compliance is detected, the individual can be contacted either in person or for example, by telephone or via the internet to check on the status and if need be provide a schedule reminder to the individual. Data can be collected at the monitoring station as to the individual's compliance or non-compliance with the pre-established schedule. Trends can be identified.

The product delivery apparatus, in a disclosed embodiment, can be periodically loaded with appropriate products, for example, on a weekly basis. Representative types of product could include tickets which are to be dispensed for a flight, such as airline tickets, prescription medications, access key cards and the like, all without limitation.

The compartments of the dispensing unit can be covered with an openable lid or member. In one embodiment, the lid or member can be held closed by a lock until access is appropriate with the predetermined schedule. Compartments are equipped with one or more sensors indicating when the compartment has been opened or accessed by an individual.

A plurality of dispensing units or stations can be in wired or wireless communication with a common monitoring system. Signals indicating product access can be communicated to the common monitoring system.

Received signals can be compared with prestored schedules to ascertain whether the individual or individuals have appropriately accessed the product or products in accordance with the prestored schedule. Optional feedback can be provided from the monitoring station to the individual or individuals inquiring as to the status thereof, whether the product is going to be accessed as expected, and/or offering suggestions or help as needed.

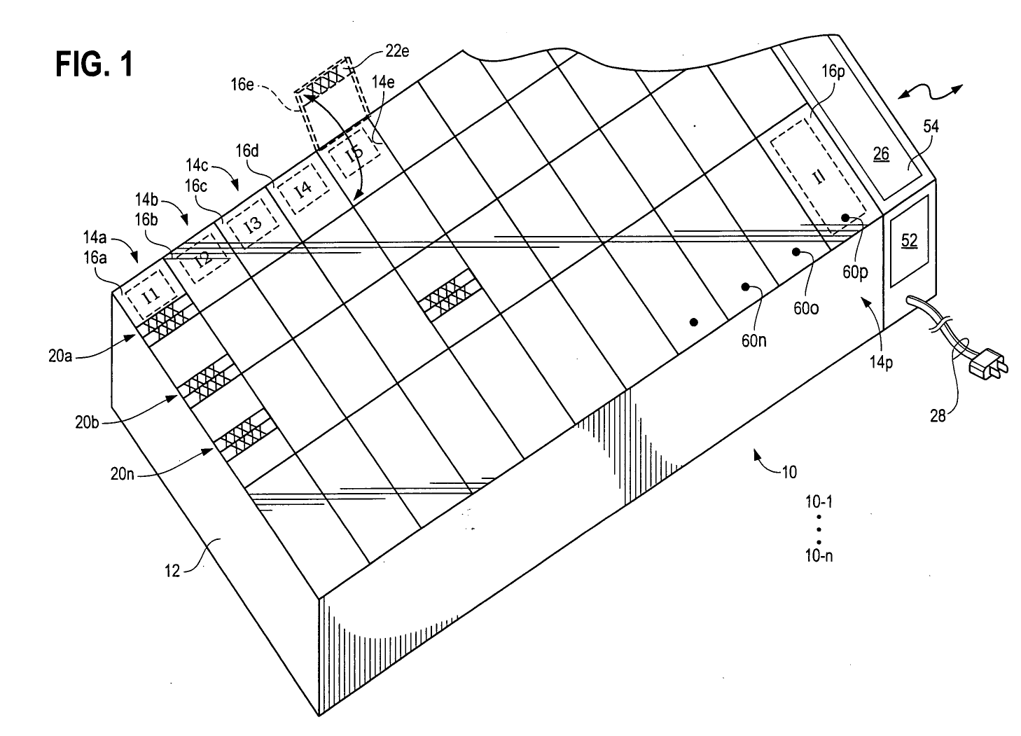

FIG. 1 is a perspective view of a dispensing apparatus 10 in accordance with the invention. The apparatus 10 includes a housing 12 which defines a plurality of internal containers, compartments or regions such as 14a, 14b, . . . 14p. Each of the internal containers or compartments is closed with a cover or lid such as 16a, 16b . . . 16e . . . 16p.

Each of the compartment covers, such as representative cover 16e can be opened, illustrated in phantom in FIG. 1, for access to the respective compartment. The compartments can be used to temporarily store a plurality of different products, such as I1, I2 . . . I1. It will be understood that the nature, shape, size and the like of the products are not limitations of the present invention. Representative products could include tickets, such as airline tickets, cards, such as dispensable value carrying cards or access cards, prescription medications and the like, all without limitation.

If desired, the various compartments such as 14a, b . . . could each carry a reminder of day and time indicia indicated generally at 20a . . . 20k . . . 20n all without limitation. The day and time indicia, if desired, could be color coded.

Additional indicia could be provided on an underside of the respective covers, such as indicia 22e of compartment 14e. The supplemental or additional indicia 22e would be viewable only when the respective container was opened, as illustrated in FIG. 1.

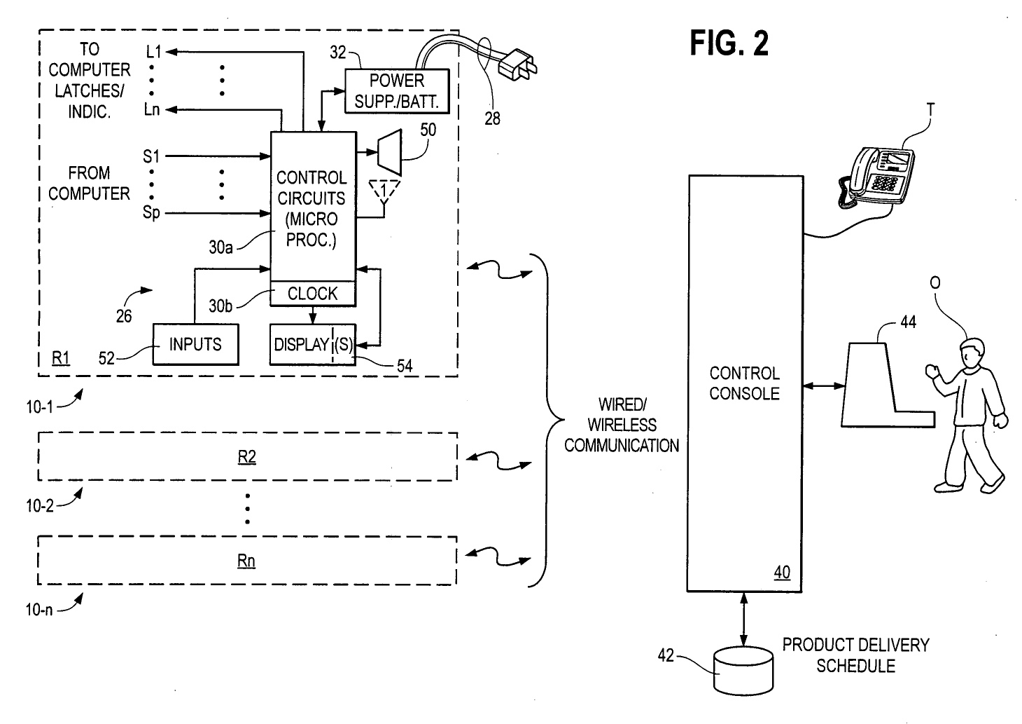

Dispensing unit 10 includes an electronic section 26, circuitry for which is best seen in FIG. 2. The unit 10 can be energized off of utility supplied power, via cord and plug 28. The utility supplied power can be supplemented with a battery backup.

Representative circuitry 26, relative to FIG. 2, can include dispensing unit control circuitry 30a, which could be implemented at least in part with a processor and prestored instructions. The control circuits 30a can also incorporate a time and day clock 30b for locally checking times of access.

Each of the units 10-1, -2, -n (which correspond to unit 10) can also include a power supply with battery back-up 32. A plurality of optional cover latches 34 can individually release (under control of processor 32a) each of the covers 16 to provide access to the respective member of the plurality 14.

Each of the compartments 14a . . . 14p includes at least one cover position sensor which generates a respective output signal, S1, S2 . . . Sp, which is coupled to the control circuitry 30a. The signals S1 . . . Sp provide day and time information to the control circuits 30a as to when the respective compartment has been accessed. Access information as to when one or more of the respective compartments 14i has been accessed can be coupled via a wired or wireless medium to a displaced monitoring console 40. The received signals or messages can be compared to an appropriate prestored scheduled stored in a database 42.

Control software and/or circuitry at the console 40 can then provide indicia, perhaps via graphical output device 44 to an operator O as to the relationship between when the respective compartment or compartments has been accessed and the prestored schedule. Additionally, the operator O can be informed by console 40 of instances where a product was expected to be dispensed in accordance with a prestored schedule and no access signal was received from the respective dispensing unit, such as the unit 10. In such an event, the operator O can follow up either by arranging for a personal visit to the location R1 of the unit, such as the unit 10-1 or by telephone call using telephone T or a combination of both as required.

In accordance with the invention, a plurality of units 10-1, -2, -m (all of which are substantially identical to the unit 10 of FIG. 1) can be positioned at a plurality of locations R1, R2 . . . Rm where products are to be dispensed in accordance with pre-established schedule. The units 10-I can communicate as described above, with the control console 40.

It will be understood that neither the exact nature of the schedules stored at the database 42 nor the nature of the products being dispensed are limitations of the present invention. Additional schedules can be added via the control console 40 as needed. Obsolete schedules can be deleted in the normal course of operation.

The dispensing units, such as the dispensing unit 10, can be provided with one or more of a variety of additional features as may be convenient and desirable. For example, unit 10 could incorporate an audio output transducer, such as a speaker 50 for the purpose of enunciating prestored or pre-recorded reminder or alert messages. These could include, without limitation, a message that it is an appropriate day and time to access a product from one of the containers and/or one or more confirmatory responses indicating that the appropriate compartment has been accessed at an appropriate day and time in accordance with a pre-stored schedule. The control circuits 30a can incorporate storage for the purpose of storing one or more product delivery schedules as might be convenient and desirable. Such schedules could be downloaded, for example, from control console 40 or could be entered locally if desired. Unit 10 could also include speech synthesis circuitry as would be understood by those of skill in the art.

Unit 10 could also incorporate a plurality of inputs 52 which could include manual means to control the volume of any audible outputs from speaker 50, a microphone for recording one or more reminder and/or confirmatory messages, a switch or keyboard or other form of manually operable input device to disable the audible outputted messages, set the unit 10 for recording messages or schedules or the like, all without limitation.

One of more visual displays 54 can be carried on unit 10 for providing a time of day and day of the week output off of clock 30b, light emitting diodes or other visual indicators as to status, for example, that it is time and an appropriate date to open a container. If desired, the number of the appropriate container could also be presented on display 54 as an aid to the person using the unit 10. The control circuits 30a could also provide control signals to a plurality of light emitting diodes or other output indicators 60a,b . . . p associated with respective containers to illuminate an indicator identifying a compartment or a container to be opened.

Additionally, control circuits 30a could detect, based on inputs from sensors S1 . . . Sp, when unit 10 has dispensed all of the prestored product and it is necessary to refill same. Appropriate messages can be forwarded to control console 40 in this regard. Additional features can be added, all without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modification as fall with the scope of the claims.

1. A dispenser comprising:
a housing with, a plurality of product containers;
sensors, associated with at least some of the containers for responding to access to the respective containers and for emitting a signal indicative thereof; and
an interface for communicating representations of the signals to a displaced site.

2. A dispenser as in claim 1 where the communicated representations include an indicium indicative of time of access to the respective container.

3. A dispenser as in claim 2 which emits a reminder indicium associated with access of a respective one of the containers.

4. A dispenser as in claim 3 which includes day specifying indicia associated with respective of the containers.

5. A dispenser as in claim 2 which includes day specifying indicia associated with respective of the containers.

6. A dispenser as in claim 2 where the interface comprises circuitry for at least one of, transmitting the signals, at least in part, via a wireless medium, or, transmitting the signals, at least in part, via a wired medium.

7. A dispenser as in claim 6 where the interface includes circuitry for emitting a local reminder relative to accessing at least some of the containers.

8. A dispenser as in claim 7 which carries day identifying indicia associated with respective ones of the containers.

9. A dispenser as in claim 8 where the containers are closeable and define an interior product receiving region.

10. A product dispensing method comprising:
providing a plurality of products;
sensing when the members of the plurality are individually accessed;
transmitting a confirmation signal indicative of one of the products being accessed.

11. A method as in claim 10 which includes enabling access in accordance with a predetermined schedule.

12. A method as in claim 11 including establishing the schedule.

13. A method as in claim 12 which includes transmitting access day and time as part of the confirmation signal.

14. A method as in claim 10 which includes providing an indicator when a respective product is to be accessed.

15. A method as in claim 10 which includes comparing the confirmation signal to a pre-established schedule.

16. A method as in claim 15 which includes, responsive to the comparing, generating a notice where the confirmation signal differs from the pre-established schedule.

17. A method as in claim 15 which includes establishing a product delivery schedule.

18. A method as in claim 10 which includes establishing a product delivery schedule.

19. A method as in claim 18 where the confirmation signal is compared to the product delivery schedule.

20. A method as in claim 10 which includes transmitting a plurality of confirmation signals indicative of a plurality of respective products being accessed.

21. A product dispensing container comprising:
a multi-compartmented housing;
control circuits carried by the housing that sense access to at least some of the containers;
the control circuits activation indicia that are indicative of at least one compartment to be accessed.

22. A container as in claim 21 which includes interface circuitry coupled to the control circuits facilitating transmitting access information to a displaced location.

23. A container as in claim 22 which includes at least one of an audio input transducer, an audio output transducer, speech output circuitry, a visual display of temporal information, or an output of product indicator.

24. A container as in claim 23 which includes circuitry to store at least one product dispensing schedule, the control circuits activating the indicia in accordance with the at least one stored schedule.
